(19) United States
(12) Patent Application Publication
(10) Pub. No.: US 2024/0028937 A1
(43) Pub. Date: Jan. 25, 2024

(54) METHOD FOR EVALUATING HEALTH STATUS OF PETROCHEMICAL ATMOSPHERIC OIL STORAGE TANK USING DATA FROM MULTIPLE SOURCES

(71) Applicant: FUJIAN SPECIAL EQUIPMENT INSPECTION AND RESEARCH INSTITUTE, Fuzhou (CN)

(72) Inventors: Honghua Zhang, Fuzhou (CN); Qinda Zeng, Fuzhou (CN); Yuanyue Zeng, Fuzhou (CN); Gengfeng Zheng, Fuzhou (CN); Chunrong Huang, Fuzhou (CN); Yao Lin, Fuzhou (CN); Ning Lin, Fuzhou (CN); Ting Xiao, Fuzhou (CN)

(21) Appl. No.: 18/027,122

(22) PCT Filed: Mar. 12, 2021
(86) PCT No.: PCT/CN2021/080526

§ 371 Date: Mar. 20, 2023

(30) Foreign Application Priority Data
Mar. 16, 2020 (CN) 202010182513.4

(51) Int. Cl. G06N 7/02

(52) U.S. Cl. CPC G06N 7/02

(57) ABSTRACT

A method for evaluating the health status of a petrochemical atmospheric oil storage tank using data from multiple sources. The health status of an atmospheric oil storage tank is influenced by multiple factors, and is evaluated by: acquiring corresponding sensor data and comprehensively considering the sensor data along with basic data of the oil storage tank, and selecting from a dynamic monitoring parameter-based health status and a basic health status of the oil storage tank, the one having a greater severity level, so as to determine the final health status of the oil storage tank. The method is used to conduct a comprehensive scientific assessment of the health status of an oil storage tank, and improves the use safety of the oil storage tank.

### TECHNICAL FIELD

The present disclosure relates to a field of device health status evaluation applications, and more particularly, to a method for evaluating the health status of a petrochemical atmospheric oil storage tank using data from multiple sources.

### BACKGROUND

At present, atmospheric oil storage tanks in the petrochemical industry guarantee safety of a reservoir region mainly through a safety management model combining regular manual inspection and fixed-point monitoring and alarming system; however, with vigorous development of the petrochemical industry, increasing scale of oil storage tanks, and enlargement and precision of oil storage tank specifications, the existing model of detection appears to be relatively low in accuracy and efficiency.

There are many factors influencing safety of oil storage tanks. At present, there is no multi-factor comprehensive, efficient, and scientific health status evaluating system involving petrochemical oil storage tanks.

### SUMMARY

In order to overcome the above-described problems, an objective of the present disclosure is to provide a method for evaluating the health status of a petrochemical atmospheric oil storage tank using data from multiple sources, for performing scientific comprehensive evaluation on an oil storage tank health status, which improves safety of use of the oil storage tanks.

The present disclosure adopts solutions below to implement: a method for evaluating the health status of a petrochemical atmospheric oil storage tank using data from multiple sources, the evaluating method including steps of: step 1: determining oil storage tank health status influencing factors, collecting parameters of the influencing factors, and obtaining an abnormality occurrence probability of each parameter;

Step 2: establishing a probability membership distribution function of parameter abnormalities under the health status, and acquiring a health status grade membership matrix under probability influence;

Step 3: establishing a health status grade membership distribution function, and acquiring a health status grade membership matrix under parameter abnormality severity influence;

Step 4: acquiring a membership vector of the parameter abnormality severity to the health status under comprehensive influence;

Step 5: determining an oil storage tank dynamic monitoring parameter health status;

Step 6: establishing an oil storage tank status set and status evaluation set, and acquiring importance weight coefficients of respective basic parameters of the oil storage tank;

Step 7: determining degradation degrees of respective basic parameters of the oil storage tank;

Step 8: establishing a basic parameter degradation degree judgment matrix, and performing oil storage tank basic parameter fuzzy comprehensive evaluation;

Step 9: determining an oil storage tank basic health status according to a maximum membership principle;

Step 10: taking severity grades in the oil storage tank dynamic monitoring parameter health status and the oil storage tank basic health status, and determining a final oil storage tank health status.

Further, the step 1 further specifically includes steps of: step 11: through oil storage tank health status influence analysis, selecting parameters for online monitoring, including but not limited to five parameters below: temperature in tank recorded as parameter A, pressure in tank recorded as parameter B, liquid level in tank recorded as parameter C, vibration data of pipeline recorded as parameter D, and lightning protection grounding resistance recorded as parameter E; and collecting the monitoring parameters and transmitting the same to a data processing server through a network;

Step 12: comparing each parameter with a corresponding normal range value preset; if the parameter exceeds the normal range, recording as an abnormality, and counting the number of abnormalities for test data analysis;

Step 13: obtaining a parameter abnormality probability through test data analysis; wherein, the smaller the probability, the better the oil storage tank health status.

Further, the step 2 further specifically includes steps of: step 21: if the smaller the probability value of abnormality occurrence of the monitoring parameter, the better the health status, within a set confidence interval, according to distribution characteristics of probability p of abnormality occurrence of each parameter, then selecting triangular distribution as a parameter abnormality probability membership distribution function under the health status, including:

$${μ}_{1} ( p ) = \{ \begin{matrix}1 & ( p = 0 ) \\ \frac{0.4 - p}{0.4} & ( 0 < p < 0.4 ) \\ 0 & ( 0.4 \leq p \leq 1 )\end{matrix} \\ {μ}_{2} ( p ) = \{ \begin{matrix}0 & ( 0 \leq p < 0.2 ) \\ \frac{p - 0.2}{0.2} & ( 0.2 \leq p < 0.4 ) \\ \frac{0.6 - p}{0.2} & ( 0.4 \leq p < 0.6 \\ 0 & ( 0.6 \leq p \leq 1 )\end{matrix} \\ {μ}_{3} ( p ) = \{ \begin{matrix}0 & ( 0 \leq p < 0.4 ) \\ \frac{p - 0.4}{0.2} & ( 0.4 \leq p < 0.6 ) \\ \frac{0.8 - p}{0.2} & ( 0.6 \leq p < 0.8 ) \\ 0 & ( 0.8 \leq p \leq 1 )\end{matrix} \\ {μ}_{4} ( p ) = \{ \begin{matrix}0 & ( 0 \leq p < 0.6 ) \\ \frac{p - 0.6}{0.2} & ( 0.6 \leq p < 0.8 ) \\ \frac{1 - p}{0.2} & ( 0.8 \leq p < 0.1 ) \\ 0 & ( p = 1 )\end{matrix} \\ {μ}_{5} ( p ) = \{ \begin{matrix}0 & ( 0 \leq p < 0.6 ) \\ \frac{p - 0.6}{0.4} & ( 0.6 \leq p < 1 ) \\ 1 & ( p = 1 )\end{matrix}$$

Step 21: substituting abnormality probability values corresponding to the monitoring parameter A, parameter B, parameter C, parameter D and parameter E into the probability membership distribution function, so that the health status membership vectors under single-factor influence are respectively V_{A1}, V_{B1}, V_{C1}, V_{D1}, V_{E1}.

Further, the step 3 further specifically includes steps of: step 31: setting a parameter abnormality severity grade q, wherein, influence characteristics of the parameter abnormality severity and the parameter abnormality occurrence probability on the health status are the same, then also selecting triangular distribution as a health status grade membership distribution function of the parameter abnormality severity, comprising:

$${μ}_{1} ( q ) = \{ \begin{matrix}1 & ( q = 0 ) \\ \frac{0.4 - q}{0.4} & ( 0 < q < 0.4 ) \\ 0 & ( 0.4 \leq q \leq 1 )\end{matrix} \\ {μ}_{2} ( q ) = \{ \begin{matrix}0 & ( 0 \leq q < 0.2 ) \\ \frac{q - 0.2}{0.2} & ( 0.2 \leq q < 0.4 ) \\ \frac{0.6 - q}{0.2} & ( 0.4 \leq q < 0.6 ) \\ 0 & ( 0.6 \leq q \leq 1 )\end{matrix} \\ {μ}_{3} ( q ) = \{ \begin{matrix}0 & ( 0 \leq q < 0.4 ) \\ \frac{q - 0.4}{0.2} & ( 0.4 \leq q < 0.6 ) \\ \frac{0.8 - q}{0.2} & ( 0.6 \leq q < 0.8 ) \\ 0 & ( 0.8 \leq q \leq 1 )\end{matrix} \\ {μ}_{4} ( q ) = \{ \begin{matrix}0 & ( 0 \leq q < 0.6 ) \\ \frac{q - 0.6}{0.2} & ( 0.6 \leq q < 0.8 ) \\ \frac{1 - q}{0.2} & ( 0.8 \leq q < 1 ) \\ 0 & ( q = 1 )\end{matrix} \\ {μ}_{5} ( q ) = \{ \begin{matrix}0 & ( 0 \leq q < 0.6 ) \\ \frac{q - 0.6}{0.4} & ( 0.6 \leq q < 1 ) \\ 1 & ( q = 1 )\end{matrix}$$

Step 32: selecting a maximum score value of the respective severity grades to substitute into the health status grade membership distribution function, so that the health status membership vectors under single-factor parameter abnormality severity influence may be obtained, which are respectively V_{A2}, V_{B2}, V_{C2}, V_{D2}, V_{E2}.

Further, the step 4 is further specifically as follows:

Respectively performing grey correlation of the health status membership vectors V_{A1}, V_{B1}, V_{C1}, V_{D1}, V_{E1} of the respective parameters under dynamic monitoring parameter abnormality probability influence and the health status membership vectors V_{A2}, V_{B2}, V_{C2}, V_{D2}, V_{E2} of the respective parameters under parameter abnormality severity influence with a jth health status grade vector v₀ⱼ; where, j is a health status grade, divided into healthy, good, attentive, worse and ill, which is recorded as 1, . . . , 5; that is, ν₀ⱼ is represented as: ν₀₁=(1,0,0,0,0), ν₀₂=(0,1,0,0,0), ν₀₃=(0,0,1,0,0), ν₀₄=(0,0,0,1,0), ν₀₅=(0,0,0,0,1);
According to a formula:

$${ξ}_{kij} ( m ) = \frac{{min}_{i} {min}_{m} \vert {v}_{0 j} ( m ) - {v}_{ki} ( m ) \vert + 0.5 {max}_{i} {max}_{m} \vert {v}_{0 j} ( m ) - {v}_{ki} ( m ) \vert}{\vert {v}_{0 j} ( m ) - {v}_{ki} ( m ) \vert + 0.5 {max}_{i} {max}_{m} \vert {v}_{0 j} ( m ) - {v}_{ki} ( m ) \vert}$$

Where, m is 1, . . . , 5;
k is parameters A, B, C, D, E;
Factor i is 1, 2;
j is 1, . . . , 5;

$${min}_{i} {min}_{m} \vert {v}_{0 j} ( m ) - {v}_{ki} ( m ) \vert$$

is a secondary minimum difference,

$${max}_{i} {max}_{m} \vert {v}_{0 j} ( m ) - {v}_{ki} ( m ) \vert$$

is a secondary maximum difference, |v₀ⱼ(m)−νₖᵢ(m)| is an absolute difference;
Finding ξₖᵢⱼ(m)
Reusing the formula

$${r}_{kij} = \frac{1}{5} {\sum }_{m = 1}^{5} {ξ}_{kij ( m )}$$

Where, m is 1, . . . , 5;
k is parameters A, B, C, D, E;
Factor i is 1,2;
j is 1, . . . , 5;
Finding rₖᵢⱼ,
Reusing the formula

$${r}_{ki}^{′} = \frac{1}{5} {\sum }_{j = 1}^{5} {r}_{kij}$$

Calculating to obtain r′ₖᵢ,
Calculating to obtain weight vectors Rₖ=(r′ₖ₁, r′ₖ₂), that is: R_{A}=(r′_{A1}, r′_{A2}), R_{B}=(r′_{B1}, r′_{B2}), R_{C}=(r′_{C1}, r′_{C2}), R_{D}=(r′_{D1}, r′_{D2}), R_{E}=(r′_{E1}, r′_{E2}),
Respectively composing matrices V_{A}, V_{B}, V_{C}, V_{D} and V_{E}, by v_{A1} and V_{A2}, v_{B1} and v_{B2}, V_{C1} and V_{C2}, V_{D1} and V_{D2}, V_{E1} and V_{E2},

$${V}_{A} = ( \begin{matrix}{V}_{A 1} \\ {V}_{A 2}\end{matrix} ) , {V}_{B} = ( \begin{matrix}{V}_{B 1} \\ {V}_{B 2}\end{matrix} ) , {V}_{C} = ( \begin{matrix}{V}_{C 1} \\ {V}_{C 2}\end{matrix} ) , {V}_{D} = ( \begin{matrix}{V}_{D 1} \\ {V}_{D 2}\end{matrix} ) , {V}_{E} = ( \begin{matrix}{V}_{E 1} \\ {V}_{E 2}\end{matrix} ) ,$$

and substituting

Hₖ=Rₖ−Vₖ

Where, k is parameters A, B, C, D, E;

So that the health status membership vectors of the five parameters A, B, C, D, E of the oil storage tank under comprehensive influence of the parameter abnormality occurrence probability and the parameter abnormality severity may be obtained, which are respectively H_{A}, H_{B}, H_{C}, H_{D}, H_{E}.

Further, the step 5 is further specifically as follows: setting the oil storage tank dynamic monitoring parameter health status grades under comprehensive influence of the dynamic monitoring parameter abnormality probability and the dynamic monitoring parameter abnormality severity as: healthy, good, attentive, worse and ill; and then obtaining the oil storage tank dynamic monitoring parameter health status grades corresponding to the five parameters A, B, C, D, E of the oil storage tank according to the maximum membership principle, through the health status membership vectors H_{A}, H_{B}, H_{C}, H_{D}, H_{E}.

Further, the step 6 is further specifically as follows: the respective basic parameters of the oil storage tank including: date of application and transformation, mounting quality of coating, insulation and lining, historical inspection and detection data of atmospheric oil storage tank, construction materials and nominal thickness of wall plates and bottom plates of respective layers, sequentially coding the four items of basic data are as U1, U2, U3, U4; according to the respective items of basic data of the oil storage tank, the oil storage tank status set being: U=(U1, U2, U3, U4); according to the oil storage tank dynamic monitoring parameter health status grades: healthy, good, attentive, worse and ill; then setting the oil storage tank health status grades to respectively correspond to: I, II, III, IV, V, then the oil storage tank status evaluation set being G=(I, II, III, IV, V); according to the oil storage tank status set and status evaluation set, determining the weight coefficients of the four items of basic parameters respectively as: weight W₁, weight W₂, weight W₃, weight W₄.

Further, the step 7 is further specifically as follows: calculating the degradation degree according to actual service time of the oil storage tank, according to the basic parameter U1 date of application and transformation; that is, a degradation degree calculation formula is:

Iᵢ=(t/T)^{k}

Where: i=1, t is the service time of the oil storage tank; T is average failure life of the oil storage tank; k is a failure index, and k is taken as 1 or 2;

With respect to U2 mounting quality of coating, insulation and lining, U3 historical inspection and detection data of atmospheric oil storage tank, U4 construction materials and nominal thickness of wall plates and bottom plates of respective layers, these basic parameters firstly go through a degradation estimation formula:

Iᵢ=(X·P₁+Y·P₂+Z·P₃)/(P₁+P₂+P₃),i=2,3,4

Where: X, Y, Z are coefficients whose values are between 0 and 1, 0 represents healthy, 1 represents completely degraded; P₁, P₂, P₃ are respectively weights of designers, quality inspectors and experts in the industry;

Finding a solution, and then calculating in combination with the average failure life of the oil storage tank, by using the formula:

$$\begin{matrix}{l}_{i} = {( \frac{t}{( 1 - {l}_{i}^{′} ) T} )}^{k} & i = 2 , 3 , 4\end{matrix} ;$$

Where: t is the service time of the oil storage tank; T is the average failure life of the oil storage tank; k is the failure index, and k is taken as 1 or 2;

Calculating the degradation degrees of the basic parameters U2, U3, U4.

Further, the step 8 is further specifically as follows:

Deriving membership of health status grades according to the degradation degrees of the respective basic parameters, by using a ridge distribution membership function:

$${r}_{I} ( {l}_{i} ) = \{ \begin{matrix}1 & ( {l}_{i} = 0 ) \\ 0.5 - 0.5 sin [ π ( {l}_{i} - 0.1 ) / 0.2 ] & ( 0 < {l}_{i} \leq 0.2 ) \\ 0 & ( {l}_{i} > 0.2 )\end{matrix} \\ {r}_{II} ( {l}_{i} ) = \{ \begin{matrix}0 & ( {l}_{i} = 0 ) \\ 0.5 + 0.5 sin [ π ( {l}_{i} - 0.1 ) / 0.2 ] & ( 0 < {l}_{i} \leq 0.2 ) \\ 0.5 - 0.5 sin [ π ( {l}_{i} - 0.35 ) / 0.3 ] & ( 0.2 < {l}_{i} \leq 0.5 ) \\ 0 & ( {l}_{i} > 0.5 )\end{matrix} \\ {r}_{III} ( {l}_{i} ) = \{ \begin{matrix}0 & ( {l}_{i} \leq 0.2 ) \\ 0.5 + 0.5 sin [ π ( {l}_{i} - 0.35 ) / 0.3 ] & ( 0.2 < {l}_{i} \leq 0.5 ) \\ 0.5 - 0.5 sin [ π ( {l}_{i} - 0.65 ) / 0.3 ] & ( 0.5 < {l}_{i} \leq 0.8 ) \\ 0 & ( {l}_{i} > 0.8 )\end{matrix} \\ {r}_{IV} ( {l}_{i} ) = \{ \begin{matrix}0 & ( {l}_{i} \leq 0.5 ) \\ 0.5 + 0.5 sin [ π ( {l}_{i} - 0.65 ) / 0.3 ] & ( 0.5 < {l}_{i} \leq 0.8 ) \\ 0.5 - 0.5 sin [ π ( {l}_{i} - 0.9 ) / 0.2 ] & ( 0.8 < {l}_{i} < 1 ) \\ 0 & ( {l}_{i} \geq 1 )\end{matrix} \\ {r}_{V} ( {l}_{i} ) = \{ \begin{matrix}0 & ( {l}_{i} \leq 0.8 ) \\ 0.5 + 0.5 sin [ π ( {l}_{i} - 0.9 ) / 0.2 ] & ( 0.8 < {l}_{i} < 1 ) \\ 1 & ( {l}_{i} \geq 1 )\end{matrix}$$

So that a fuzzy evaluation matrix with the degradation degree as evaluation criteria may be obtained as follows:

$${R}_{i} = ( {r}_{I} ( {l}_{i} ) , {r}_{I I} ( {l}_{i} ) , {r}_{I I I} ( {l}_{i} ) , {r}_{I V} ( {l}_{i} ) , {r}_{V} ( {l}_{i} ) )$$

$$R = ( \begin{matrix}{r}_{I} ( {l}_{1} ) , & {r}_{I I} ( {l}_{1} ) , & {r}_{I I I} ( {l}_{1} ) , & {r}_{IV} ( {l}_{1} ) , & {r}_{V} ( {l}_{1} ) \\ {r}_{I} ( {l}_{2} ) , & {r}_{I I} ( {l}_{2} ) , & {r}_{I I I} ( {l}_{2} ) , & {r}_{IV} ( {l}_{2} ) , & {r}_{V} ( {l}_{2} ) \\ {r}_{I} ( {l}_{3} ) , & {r}_{I I} ( {l}_{3} ) , & {r}_{I I I} ( {l}_{3} ) , & {r}_{IV} ( {l}_{3} ) , & {r}_{V} ( {l}_{3} ) \\ {r}_{I} ( {l}_{4} ) , & {r}_{I I} ( {l}_{4} ) & {r}_{I I I} ( {l}_{4} ) , & {r}_{IV} ( {l}_{4} ) , & {r}_{V} ( {l}_{4} )\end{matrix} )$$

Then the fuzzy comprehensive evaluation of the oil storage tank basic parameters being:

E=W·R

Where, W is the weight coefficients of the four items of basic parameters W=(W₁, W₂, W₃, W₄).

Further, the step 9 is further specifically as follows: obtaining values of healthy, good, attentive, worse and ill which the oil storage tank belongs to from the fuzzy comprehensive evaluation results; and then judging which state among healthy, good, attentive, worse and ill the oil storage tank basic parameters belong to according to the maximum membership principle.

Advantageous effects of the present disclosure are that: the present disclosure discloses a method for evaluating the health status of a petrochemical atmospheric oil storage tank using data from multiple sources, wherein, sensor monitoring is used to collect data related to device failure and safety, in combination with the basic data of the oil storage tank, to perform scientific and comprehensive evaluation on the oil storage tank health status, which not only improves safety of use of the oil storage tanks, but also ensures service life of the petrochemical atmospheric oil storage tanks.

### BRIEF DESCRIPTION OF THE DRAWINGS

FIG. 1 is a schematic flow chart of the method according to the present disclosure.

### DETAILED DESCRIPTION

Hereinafter, the present disclosure will be further described with reference to the accompanying drawings.

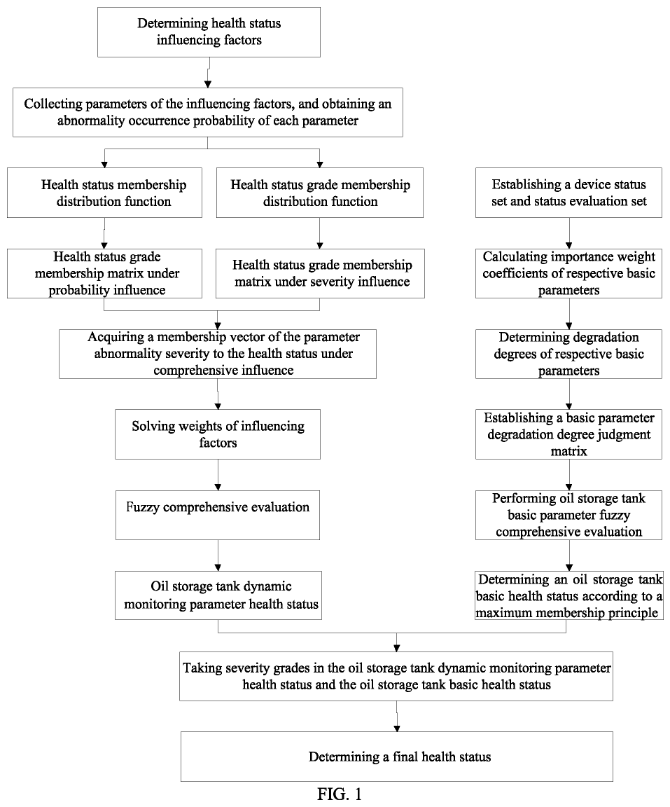

As shown in FIG. 1, the present disclosure provides a method for evaluating the health status of a petrochemical atmospheric oil storage tank using data from multiple sources, the evaluating method including steps of: step 1: determining oil storage tank health status influencing factors, collecting parameters of the influencing factors, and obtaining an abnormality occurrence probability of each parameter;

Step 2: establishing a probability membership distribution function of parameter abnormalities under the health status, and acquiring a health status grade membership matrix under probability influence;

Step 3: establishing a health status grade membership distribution function, and acquiring a health status grade membership matrix under parameter abnormality severity influence;

Step 4: acquiring a membership vector of the parameter abnormality severity to the health status under comprehensive influence;

Step 5: determining an oil storage tank dynamic monitoring parameter health status;

Step 6: establishing an oil storage tank status set and status evaluation set, and acquiring importance weight coefficients of respective basic parameters of the oil storage tank;

Step 7: determining degradation degrees of respective basic parameters of the oil storage tank;

Step 8: establishing a basic parameter degradation degree judgment matrix, and performing oil storage tank basic parameter fuzzy comprehensive evaluation;

Step 9: determining an oil storage tank basic health status according to a maximum membership principle;

Step 10: taking severity grades in the oil storage tank dynamic monitoring parameter health status and the oil storage tank basic health status, and determining a final oil storage tank health status.

Hereinafter, the present disclosure is further described as follows: step S1: comprehensively considering factors influencing safety of the oil storage tank, selecting parameters for online monitoring, including but not limited to five parameters below: temperature in tank (recorded as parameter A), pressure in tank (recorded as parameter B), liquid level in tank (recorded as parameter C), vibration data of pipeline (recorded as parameter D), and lightning protection grounding resistance (recorded as parameter E). Appropriate portions of the oil storage tank are respectively mounted with corresponding parameter collecting sensors.

Step S2: collecting and preprocessing, by the data collecting device, data of the respective sensors; transmitting the preprocessed data to a data processing server through a network to process and manage the data. The health status evaluating system compares each parameter with a corresponding normal range value preset; if the parameter exceeds the normal range, records as an abnormality, and counts the number of abnormalities for use in test data analysis;

Step S3: obtaining a parameter abnormality probability through test data analysis; wherein, the smaller the probability, the better the oil storage tank health status; that is, counting an abnormality occurrence probability of each parameter according to historical formal operation days (the number of abnormality occurrences within the formal operation days/the formal operation days);

Step S4: a parameter abnormality severity grade corresponding to each parameter: I (very strong), II (strong), III (medium), IV (mild); referring to Table 1 below

| Monitoring | Parameter abnormality | Parameter abnormality |
|---|---|---|
| parameter | probability (p) | severity grade (q) |
| A | Statistics of historical formal | Expert evaluation q_{A} |
| | operation days p_{A} | |
| B | Statistics of historical formal | Expert evaluation q_{B} |
| | operation days p_{B} | |
| C | Statistics of historical formal | Expert evaluation q_{C} |
| | operation days p_{C} | |
| D | Statistics of historical formal | Expert evaluation q_{D} |
| | operation days p_{D} | |
| E | Statistics of historical formal | Expert evaluation q_{E} |
| | operation days p_{E} | |

Step S5: establishing a membership distribution function. The smaller the probability value of abnormality occurrence of the monitoring parameter, the better the health status, within a set confidence interval, according to distribution characteristics of abnormality probability. Triangular distribution may be selected as a health status membership distribution function of parameter abnormality probability factors, including:

$${μ}_{1} ( p ) = \{ \begin{matrix}1 & ( p = 0 ) \\ \frac{0.4 - p}{0.4} & ( 0 < p < 0.4 ) \\ 0 & ( 0.4 \leq p \leq 1 )\end{matrix} \begin{matrix} \\ \\ \end{matrix}$$

$${μ}_{2} ( p ) = \{ \begin{matrix}0 & ( 0 \leq p < 0.2 ) \\ \frac{p - 0.2}{0.2} & ( 0.2 \leq p < 0 \text{.4} ) \\ \frac{0.6 - p}{{0}^{0.2}} & 0.4 \leq p < 0.6 ) \\ 0 & ( 0.6 \leq p \leq 1 )\end{matrix}$$

$${μ}_{3} ( p ) = \{ \begin{matrix}0 & ( 0 \leq p < 0.4 ) \\ \frac{p - 0.4}{0.2} & ( 0.4 \leq p < 0.6 ) \\ \frac{0.8 - p}{0.2} & ( 0.6 \leq p < 0.8 ) \\ 0 & ( 0.8 \leq p \leq 1 )\end{matrix}$$

$${μ}_{4} ( p ) = \{ \begin{matrix}0 & ( 0 \leq p < 0.6 ) \\ \frac{p - 0.6}{0.2} & ( 0.6 \leq p < 0.8 ) \\ \frac{1 - p}{0.2} & ( 0.8 \leq p < 0.1 ) \\ 0 & ( p = 1 )\end{matrix}$$

$${μ}_{5} ( p ) = \{ \begin{matrix}0 & ( 0 \leq p < 0.6 ) \\ \frac{p - 0.6}{0.4} & ( 0.6 \leq p < 1 ) \\ 1 & ( p = 1 )\end{matrix}$$

Step S6: calculating the health status membership vectors;

Substituting abnormality probability values of state parameters A, B, C, D, E into the membership distribution function, so that the health status membership vectors under single-factor influence may be obtained, which are respectively:

$$\{ \begin{matrix}{V}_{A 1} \\ {V}_{B 1} \\ {V}_{C 1} \\ {V}_{D 1} \\ {V}_{E 1}\end{matrix}$$

Step S7: determining the atmospheric oil storage tank health status grades under probability influence;

So that respective values of the health status grades under abnormality influence of state parameters of A, B, C, D, E may be obtained (the health status grades are divided into “healthy”, “good”, “attentive”, “worse” and “μl”), based on the maximum membership principle, according to the calculation results of S6.

Parameter abnormality severity factor analysis

Step S8: establishing a severity grade scoring criteria;

Scoring of the severity grade is based on a 10-point system, with grades I to IV corresponding to 1 to 10 points, each grade corresponding to 2 to 3 points. For convenience of analysis, the corresponding scores may be compressed to 0.1 to 1.0, as shown in Table 2.

TABLE 2
Severity grade scoring criteria

| Severity grade | Scoring criteria | Compressed scoring criteria |
|---|---|---|
| IV (mild) | 1, 2, 3 | 0.1, 0.2, 0.3 |
| III (medium) | 4, 5, 6 | 0.4, 0.5, 0.6 |
| II (strong) | 7, 8 | 0.7, 0.8 |
| I (very strong) | 9, 10 | 0.9, 1.0 |

Step S9: establishing a parameter abnormality severity membership distribution function;

Influence characteristics of the parameter abnormality severity and the parameter abnormality probability on the health status are the same, so triangular distribution is also selected as the health status membership distribution function of the parameter abnormality severity, similarly including:

$${μ}_{1} ( q ) = \{ \begin{matrix}1 & ( q = 0 ) \\ \frac{0.4 - q}{0.4} & ( 0 < q < 0.4 ) \\ 0 & ( 0.4 \leq q \leq 1 )\end{matrix}$$

$${μ}_{2} ( q ) = \{ \begin{matrix}0 & ( 0 \leq q < 0.2 ) \\ \frac{q - 0.2}{0.2} & ( 0.2 \leq q < 0.4 ) \\ \frac{0.6 - q}{0.2} & 0.4 \leq q < 0.6 ) \\ 0 & ( 0.6 \leq q \leq 1 )\end{matrix}$$

$${μ}_{3} ( q ) = \{ \begin{matrix}0 & ( 0 \leq q < 0.4 ) \\ \frac{q - 0.4}{0.2} & ( 0.4 \leq q < 0.6 ) \\ \frac{0.8 - q}{0.2} & ( 0.6 \leq q < 0.8 ) \\ 0 & ( 0.8 \leq q \leq 1 )\end{matrix}$$

$${μ}_{4} ( q ) = \{ \begin{matrix}0 & ( 0 \leq q < 0.6 ) \\ \frac{q - 0.6}{0.2} & ( 0.6 \leq q < 0.8 ) \\ \frac{1 - q}{0.2} & ( 0.8 \leq q < 0.1 ) \\ 0 & ( q = 1 )\end{matrix}$$

$${μ}_{5} ( q ) = \{ \begin{matrix}0 & ( 0 \leq q < 0.6 ) \\ \frac{q - 0.6}{0.4} & ( 0.6 \leq q < 1 ) \\ 1 & ( q = 1 )\end{matrix}$$

Step S10: calculating the membership vectors of the dynamic monitoring parameter abnormality severity to the health status;

And selecting a maximum score value, with respect to the state severity grades of state parameters A, B, C, D, E (referring to Table 1), according to the severity grade scoring criteria in Table 2, to substitute into the membership distribution function, so that health status membership vectors under single-factor influence may be obtained, which are respectively: V_{A2}, V_{B2}, V_{C2}, V_{D2}, V_{E2};

Step S11: determining the atmospheric oil storage tank health status grade under severity influence;

So that respective values of the health status grades under abnormality influence of state parameters A, B, C, D, E may be obtained (the health status grades are divided into “healthy”, “good”, “attentive”, “worse” and “μl”), based on the maximum membership principle, according to the calculation results of S10.

Atmospheric oil storage tank dynamic health status comprehensive evaluation

Step S12: calculating the membership vectors of severity to the health status under comprehensive influence;

Respectively performing grey correlation of the health status membership vectors V_{A1}, V_{B1}, V_{C1}, V_{D1}, V_{E1} of the respective parameters under dynamic monitoring parameter abnormality probability influence and the health status membership vectors V_{A2}, V_{B2}, V_{C2}, V_{D2}, V_{E2} of the respective parameters under parameter abnormality severity influence with a jth health status grade vector V₀ⱼ; where, j is a health status grade, divided into healthy, good, attentive, worse and ill, which is recorded as 1, . . . , 5; that is, v₀ⱼ is represented as: v₀₁=(1,0,0,0,0), V₀₂=(0,1,0,0,0), V₀₃=(0,0,1,0,0), V₀4=(0,0,0,1,0),V₀₅=(0,0,0,0,1);

According to a formula:

$${ξ}_{kij} ( m ) = \frac{{min}_{i} {min}_{m} \vert {v}_{oj} ( m ) - {v}_{k i} ( m ) \vert + 0.5 {max}_{i} {max}_{m} \vert {v}_{o j} ( m ) - {v}_{k i} ( m ) \vert}{\vert {v}_{oj} ( m ) - {v}_{k i} ( m ) \vert + 0.5 {max}_{i} {max}_{m} \vert {v}_{o j} ( m ) - {v}_{k i} ( m ) \vert}$$

Where m is 1, . . . , 5;

k is parameters A, B, C, D, E;

Factor i is 1,2;

j is 1, . . . , 5;

$${min}_{i} {min}_{m} \vert {v}_{0 j} ( m ) - {v}_{k i} ( m ) \vert$$

is a secondary minimum difference,

$${max}_{i} {max}_{m} \vert {v}_{0 j} ( m ) - {v}_{k i} ( m ) \vert$$

is a secondary maximum difference, |V₀ⱼ(m)−Vₖᵢ(m)| is an absolute difference;

Finding ξₖᵢⱼ(m)

Reusing the formula

$${r}_{kij} = \frac{1}{5} {\sum }_{m = 1}^{5} {ξ}_{kij ( m )}$$

Where m is 1, . . . , 5;

k is parameters A, B, C, D, E;

Factor i is 1,2;

j is 1, . . . , 5;

Finding rₖᵢⱼ

Reusing the formula

$${r}_{k i}^{′} = \frac{1}{5} {\sum }_{j = 1}^{5} {r}_{kij}$$

Calculating to obtain r′ₖᵢ,

Calculating to obtain weight vectors Rₖ=(r′ₖ₁,r′ₖ₂), that is: R_{A}=(r′_{A1}, r′_{A2}), R_{B}=(r′_{B1}, r′_{B2}), R_{C}=(r′_{C1}, r′_{C2}), R_{D}=(r′_{D1}, r′_{D2}), R_{E}=(r′_{E1}, r′_{E2}),

Respectively composing matrices V_{A}, V_{B}, V, V_{D} and V_{E}, by V_{A1} and V_{A2},V_{B1} and V_{B2}, V_{C1} and V_{C2}, V_{D1} and V_{D2}, V_{E1} and V_{E2},

$${V}_{A} = ( \begin{matrix}{V}_{A 1} \\ {V}_{A 2}\end{matrix} ) , {V}_{B} = ( \begin{matrix}{V}_{B 1} \\ {V}_{B 2}\end{matrix} ) , {V}_{C} = ( \begin{matrix}{V}_{C 1} \\ {V}_{C 2}\end{matrix} ) , {V}_{D} = ( \begin{matrix}{V}_{D 1} \\ {V}_{D 2}\end{matrix} ) , {V}_{E} = ( \begin{matrix}{V}_{E 1} \\ {V}_{E 2}\end{matrix} ) ,$$

and substituting

Hₖ=Rₖ−Vₖ

Where, k is parameters A, B, C, D, E;

So that the health status membership vectors of the five parameters A, B, C, D, E of the oil storage tank under comprehensive influence of the parameter abnormality occurrence probability and the parameter abnormality severity may be obtained, which are respectively H_{A}, H_{B}, H_{C}, H_{D}, H_{E}.

In order to make those skilled in the art more clearly understand the solving mode of the weight vectors corresponding to the respective parameters A, B, C, D, E, the weight vector R_{A} is further explained below:

For example, taking a health status membership vector V_{A1} of parameter A under influence of factor 1 and a health status membership vector V_{A2} of parameter A under influence of factor 2 as a comparison series, and taking v₀ⱼ as a reference sequence, for solving a correlation coefficient, a correlation degree and weights to obtain the weight vector R_{A}, specifically:

Step S1: solving the correlation coefficient:

Taking j=1 in v₀ⱼ, so that v₀₁=(ν₀₁(1), ν₀₁(2), ν₀₁(3), ν₀₁(4), ν₀₁(5))

According to a formula:

$${ξ}_{kij} ( m ) = \frac{{min}_{i} {min}_{m} \vert {v}_{oj} ( m ) - {v}_{k i} ( m ) \vert + 0.5 {max}_{i} {max}_{m} \vert {v}_{o j} ( m ) - {v}_{k i} ( m ) \vert}{\vert {v}_{oj} ( m ) - {v}_{k i} ( m ) \vert + 0.5 {max}_{i} {max}_{m} \vert {v}_{o j} ( m ) - {v}_{k i} ( m ) \vert}$$

Where m is 1, . . . , 5;

k is parameter A (k is a corresponding parameter when solving a weight vector of other parameter)

Factor i is 1,2;

j is 1 (corresponding parameters are 2, 3, 4, 5 if the other j types of health status grade vectors v₀ⱼ are being solved);

$${min}_{i} {min}_{m} \vert {v}_{0 j} ( m ) - {v}_{k i} ( m ) \vert$$

is a secondary minimum difference,

$${max}_{i} {max}_{m} \vert {v}_{0 j} ( m ) - {v}_{k i} ( m ) \vert$$

is a secondary maximum difference, (v₀ⱼ(m)−νₖᵢ(m)| is an absolute difference;

Finding ξ_{A11}(m) and ξ_{A21}(m);

Reusing the formula

$${r}_{kij} = \frac{1}{5} {\sum }_{m = 1}^{5} {ξ}_{kij ( m )}$$

Where m is 1, . . . , 5;

k is parameter A (k is a corresponding parameter when solving a weight vector of other parameter)

Factor i is 1,2;

j is 1 (corresponding parameters are 2, 3, 4, 5 if the other j types of health status grade vectors v₀ⱼ are being solved);

Finding r_{A11}, r_{A21};

Step S2: taking 2, 3, 4, 5 as j at this time, and respectively taking v₀ⱼ as the reference sequence, to obtain the correlation degrees r_{A1j}, r_{A2j} of parameter A according to the calculation mode in step S1;

Reusing the formula

$${r}_{k i}^{′} = \frac{1}{5} {\sum }_{j = 1}^{5} {r}_{kij}$$

Calculating to obtain r′_{A1} and r′_{A2}

Calculating to obtain the weight vector R_{A}=(r′_{A1}, r′_{A2});

Step S3: following the methods of step S1 and step S2 again, where k is respectively substituted as B, C, D, E, so that R_{B}, R_{C}, R_{D}, R_{E} may be obtained;

Respectively composing matrices V_{A}, V_{B}, V_{C}, V_{D} and V_{E}, by V_{A1} and V_{A2},V_{B1} and V_{B2}, v_{C1} and v_{C2} v_{D1} and v_{D2}, V_{E1} and v_{E2},

$${V}_{A} = ( \begin{matrix}{V}_{A 1} \\ {V}_{A 2}\end{matrix} ) , {V}_{B} = ( \begin{matrix}{V}_{B 1} \\ {V}_{B 2}\end{matrix} ) , {V}_{C} = ( \begin{matrix}{V}_{C 1} \\ {V}_{C 2}\end{matrix} ) , {V}_{D} = ( \begin{matrix}{V}_{D 1} \\ {V}_{D 2}\end{matrix} ) , {V}_{E} = ( \begin{matrix}{V}_{E 1} \\ {V}_{E 2}\end{matrix} ) ,$$

and substituting

Hₖ=Rₖ·Vₖ

Where k is parameter A, B, C, D, E;

So that the health status membership vectors of the five parameters A, B, C, D, E of the oil storage tank under comprehensive influence of the parameter abnormality occurrence probability and the parameter abnormality severity may be obtained, which are respectively H_{A}, H_{B}, H_{C}, H_{D}, H_{E}.

Step S13: determining oil storage tank dynamic monitoring health status grade;

So that respective values of the dynamic monitoring health status grades under comprehensive influence of abnormality probability of three types of dynamic monitoring parameters A, B, C, D, E of the oil storage tank and the dynamic monitoring parameter abnormality severity may be obtained (the health status grades are divided into “healthy”, “good”, “attentive”, “worse” and “μl”), based on the maximum membership principle.

Determining the oil storage tank basic health status

Basic data influencing the health status of oil storage tank mainly including: date of application and transformation, mounting quality of coating, insulation and lining, historical inspection and detection data of atmospheric oil storage tank, construction materials and nominal thickness of wall plates and bottom plates of respective layers, and the four items of basic data being sequentially coded as U1, U2, U3, U4.

Step S14: determining an oil storage tank status set and status evaluation set;

According to the oil storage tank basic data, the status set being:

U=(U1, U2,U3,U4)

If the health status of the oil storage tank is divided into five grades: “healthy”, “good”, “attentive”, “worse” and “μl”, then the status evaluation set being V=(I, II, III, IV, V)

Step S15: determining importance of the basic data;

Finally determining the weights of the four items of basic parameters as shown in Table 3, through analysis of the petrochemical oil storage tank professional data, with respect to importance analysis results of the 4 items of basic parameters,:

TABLE 3
Petrochemical oil storage tank basic parameters and weights

| | | Parameter | Weight |
|---|---|---|---|
| Object | Basic parameter | code | (Wᵢ) |
| Petro- | Date of application and | U1 | Analyze and |
| chemical | transformation | | determine W₁ |
| oil storage | Mounting quality of coating, | U2 | Analyze and |
| tank | insulation and lining | | determine W₂ |
| | Historical inspection and | U3 | Analyze and |
| | detection data of atmospheric | | determine W₃ |
| | oil storage tank | | |
| | Construction materials and | U4 | Analyze and |
| | nominal thickness of wall | | determine W₄ |
| | plates and bottom plates of | | |
| | respective layers | | |

1. Step S16: determining degradation degrees of respective items of basic data;

Using different degradation calculating methods for different basic parameters in Table 3, which are specifically:

Calculating the degradation degree according to actual service time of the device, for “date of application and transformation (U1)”.

Since it is difficult to monitor and detect the date of application and transformation, and change thereof has an approximate linear relationship with time, average failure life thereof is determined according to design data such as design life and a large amount of statistical data, and a degradation calculation formula thereof is:

Iᵢ=(t/T)^{k} 2.

1) Where: t is the service time of the oil storage tank; T is the average failure life of the oil storage tank; k is the failure index, usually 1 or 2.

For “mounting quality of coating, insulation and lining (U2),” “historical inspection and detection data of atmospheric oil storage tank (U3)”, “construction materials and nominal thickness of wall plates and bottom plates of respective layers (U4)”, since degradation degrees of these parameters are related to quality and service time of the oil storage tank per se, a comprehensive calculating method of “scoring estimation” and “actual service time” is adopted.

The degradation degree is calculated according to the designers, the quality inspectors, and the experts in the industry.

The degradation degree estimation formula thereof is:

Iᵢ=(X·P₁+Y·P₂+Z·P₃)/(P₁+P₂+P₃)i=2,3,4 2).

Where: X, Y, Z are respectively coefficients, whose values are between 0 and 1, 0 represents healthy, and 1 represents completely degraded; P₁, P₂, P₃ are respectively weights of designers, quality inspectors and experts in the industry, and values thereof reflect level and authority of the scoring personnel;

The final degradation degree is calculated comprehensively based on the average failure life determined by the design life and other data as well as a large amount of statistical data.

Then the final degradation degree calculation formula is:

$${l}_{i} = {( \frac{t}{( 1 - {l}_{i}^{′} ) T} )}^{k} \qquad i = 2 , 3 , 4$$

Were: t is the service time of the oil storage tank; T is the average failure life of the oil storage tank; k is the failure index, and k is taken as 1 or 2;

Calculating the degradation degrees of basic parameters U2, U3 and U4.

Step S17: establishing a basic parameter degradation degree judgment matrix;

Solving membership of the health status grades according to the degradation degrees; wherein, ridge distribution has characteristics of wide main value range and mild transition zone, which may better reflect the fuzzy relationship of state space of the degradation degrees of the oil storage tank, so the ridge distribution membership function is adopted:

$${r}_{I} ( {l}_{i} ) = \{ \begin{matrix}1 & ( {l}_{i} = 0 ) \\ 0.5 - 0.5 sin [ π ( {l}_{i} - 0.1 ) / 0.2 ] & ( 0 < {l}_{i} \leq 0.2 ) \\ 0 & ( {l}_{i} > 0.2 )\end{matrix} \\ {r}_{II} ( {l}_{i} ) = \{ \begin{matrix}0 & ( {l}_{i} = 0 ) \\ 0.5 + 0.5 sin [ π ( {l}_{i} - 0.1 ) / 0.2 ] & ( 0 < {l}_{i} \leq 0.2 ) \\ 0.5 - 0.5 sin [ π ( {l}_{i} - 0.35 ) / 0.3 ] & ( 0.2 < {l}_{i} \leq 0.5 ) \\ 0 & ( {l}_{i} > 0.5 )\end{matrix} \\ {r}_{III} ( {l}_{i} ) = \{ \begin{matrix}0 & ( {l}_{i} \leq 0.2 ) \\ 0.5 + 0.5 sin [ π ( {l}_{i} - 0.35 ) / 0.3 ] & ( 0.2 < {l}_{i} \leq 0.5 ) \\ 0.5 - 0.5 sin [ π ( {l}_{i} - 0.65 ) / 0.3 ] & ( 0.5 < {l}_{i} \leq 0.8 ) \\ 0 & ( {l}_{i} > 0.8 )\end{matrix} \\ {r}_{IV} ( {l}_{i} ) = \{ \begin{matrix}0 & ( {l}_{i} \leq 0.5 ) \\ 0.5 + 0.5 sin [ π ( {l}_{i} - 0.65 ) / 0.3 ] & ( 0.5 < {l}_{i} \leq 0.8 ) \\ 0.5 - 0.5 sin [ π ( {l}_{i} - 0.9 ) / 0.2 ] & ( 0.8 < {l}_{i} < 1 ) \\ 0 & ( {l}_{i} \geq 1 )\end{matrix} \\ {r}_{V} ( {l}_{i} ) = \{ \begin{matrix}0 & ( {l}_{i} \leq 0.8 ) \\ 0.5 + 0.5 sin [ π ( {l}_{i} - 0.9 ) / 0.2 ] & ( 0.8 < {l}_{i} < 1 ) \\ 1 & ( {l}_{i} \geq 1 )\end{matrix}$$

So that a fuzzy evaluation matrix with the degradation degree as evaluation criteria may be obtained as follows:

$${R}_{i} = ( \begin{matrix}{r}_{I} ( {l}_{i} ) , & {r}_{II} ( {l}_{i} ) , & {r}_{III} ( {l}_{i} ) , & {r}_{IV} ( {l}_{i} ) , & {r}_{V} ( {l}_{i} )\end{matrix} ) \\ R = ( \begin{matrix}{r}_{I} ( {l}_{1} ) , & {r}_{II} ( {l}_{1} ) , & {r}_{III} ( {l}_{1} ) , & {r}_{IV} ( {l}_{1} ) , & {r}_{V} ( {l}_{1} ) \\ {r}_{I} ( {l}_{2} ) , & {r}_{II} ( {l}_{2} ) , & {r}_{III} ( {l}_{2} ) , & {r}_{IV} ( {l}_{2} ) , & {r}_{V} ( {l}_{2} ) \\ {r}_{I} ( {l}_{3} ) , & {r}_{II} ( {l}_{3} ) , & {r}_{III} ( {l}_{3} ) , & {r}_{IV} ( {l}_{3} ) , & {r}_{V} ( {l}_{3} ) \\ {r}_{I} ( {l}_{4} ) , & {r}_{II} ( {l}_{4} ) , & {r}_{III} ( {I}_{4} ) , & {r}_{IV} ( {l}_{4} ) , & {r}_{V} ( {l}_{4} )\end{matrix} )$$

Step S18: performing fuzzy comprehensive evaluation on the oil storage tank basic parameters;

E=W·R

Where, W is W=(W₁, W₂, W₃, W₄) according to Table 3

From the fuzzy comprehensive evaluation results, program values that the device system belongs to “healthy”, “good”, “attentive”, “worse” and “μl” may be obtained, and the state of the oil storage tank basic parameters may be judged according to the maximum membership principle.

The oil storage tank dynamic monitoring health status and the basic health status are integrated to confirm the final state.

Step S19: integrating the oil storage tank dynamic monitoring health status and the basic health status to confirm the final state;

Taking a more ill grade in the oil storage tank dynamic monitoring health status and the basic health status, according to the oil storage tank dynamic monitoring parameter health status (the result of step S13) and the oil storage tank basic health status (the result of step S18) as the final health status evaluation value.

The above merely are preferred embodiments of the present disclosure, and all equivalent changes and modifications made according to the scope of the patent application for the present disclosure should be covered by the present disclosure.

What is claimed is:

1. A method for evaluating health status of a petrochemical atmospheric oil storage tank using data from multiple sources, comprising steps of:
step 1: determining influencing factors of oil storage tank health status, collecting parameters of the influencing factors, and obtaining an abnormality occurrence probability of each parameter;
step 2: establishing a probability membership distribution function of parameter abnormalities under the health status, and acquiring a health status grade membership matrix under probability influence;
step 3: establishing a health status grade membership distribution function, and acquiring a health status grade membership matrix under parameter abnormality severity influence;
step 4: acquiring a membership vector of the parameter abnormality severity to the health status under comprehensive influence;
step 5: determining an oil storage tank dynamic monitoring parameter health status;
step 6: establishing an oil storage tank status set and status evaluation set, and acquiring importance weight coefficients of respective basic parameters of the oil storage tank;
step 7: determining degradation degrees of respective basic parameters of the oil storage tank;
step 8: establishing a basic parameter degradation degree judgment matrix, and performing oil storage tank basic parameter fuzzy comprehensive evaluation;
step 9: determining an oil storage tank basic health status according to a maximum membership principle;
step 10: taking severity grades in the oil storage tank dynamic monitoring parameter health status and the oil storage tank basic health status, and determining a final oil storage tank health status.

2. The method for evaluating the health status of a petrochemical atmospheric oil storage tank using data from multiple sources according to claim 1, wherein, the step 1 further specifically comprises steps of:
step 11: through oil storage tank health status influence analysis, selecting parameters for online monitoring, including but not limited to five parameters below: temperature in tank recorded as parameter A, pressure in tank recorded as parameter B, liquid level in tank recorded as parameter C, vibration data of pipeline recorded as parameter D, and lightning protection grounding resistance recorded as parameter E; collecting the monitoring parameters and transmitting the same to a data processing server through a network;
step 12: comparing each parameter with a corresponding normal range value preset; if the parameter exceeds the normal range, recording as an abnormality, and counting the number of abnormalities for test data analysis;
step 13: obtaining a parameter abnormality probability through test data analysis; wherein, the smaller the probability, the better the oil storage tank health status.

3. The method for evaluating the health status of a petrochemical atmospheric oil storage tank using data from multiple sources according to claim 2, wherein, the step 2 further specifically includes steps of:
step 21: if the smaller the probability value of abnormality occurrence of the monitoring parameter, the better the health status, within a set confidence interval, according to distribution characteristics of probability p of abnormality occurrence of each parameter, then selecting triangular distribution as a parameter abnormality probability membership distribution function under the health status, comprising:
$${μ}_{1} ( p ) = \{ \begin{matrix}1 & ( p = 0 ) \\ \frac{0.4 - p}{0.4} & ( 0 < p < 0.4 ) \\ 0 & ( 0.4 \leq p \leq 1 )\end{matrix} \\ {μ}_{2} ( p ) = \{ \begin{matrix}0 & ( 0 \leq p < 0.2 ) \\ \frac{p - 0.2}{0.2} & ( 0.2 \leq p < 0.4 ) \\ \frac{0.6 - p}{0.2} & ( 0.4 \leq p < 0.6 ) \\ 0 & ( 0.6 \leq p \leq 1 )\end{matrix} \\ {μ}_{3} ( p ) = \{ \begin{matrix}0 & ( 0 \leq p < 0.4 ) \\ \frac{p - 0.4}{0.2} & ( 0.4 \leq p < 0.6 ) \\ \frac{0.8 - p}{0.2} & ( 0.6 \leq p < 0.8 ) \\ 0 & ( 0.8 \leq p \leq 1 )\end{matrix} \\ {μ}_{4} ( p ) = \{ \begin{matrix}0 & ( 0 \leq p < 0.6 ) \\ \frac{p - 0.6}{0.2} & ( 0.6 \leq p < 0.8 ) \\ \frac{1 - p}{0.2} & ( 0.8 \leq p < 0.1 ) \\ 0 & ( p = 1 )\end{matrix} \\ {μ}_{5} ( p ) = \{ \begin{matrix}0 & ( 0 \leq p < 0.6 ) \\ \frac{p - 0.6}{0.4} & ( 0.6 \leq p < 1 ) \\ 1 & ( p = 1 )\end{matrix}$$
step 21: substituting abnormality probability values corresponding to the monitoring parameter A, parameter B, parameter C, parameter D and parameter E into the probability membership distribution function, so that the health status membership vectors under single-factor influence are respectively v_{A1}, v_{B1}, v_{C1}, v_{D1}, v_{E1}.

4. The method for evaluating the health status of a petrochemical atmospheric oil storage tank using data from multiple sources according to claim 3, wherein, the step 3 further specifically includes steps of:
step 31: setting a parameter abnormality severity grade q, wherein, influence characteristics of the parameter abnormality severity and the parameter abnormality occurrence probability on the health status are the same, then also selecting triangular distribution as a health status grade membership distribution function of the parameter abnormality severity, comprising:
$${μ}_{1} ( q ) = \{ \begin{matrix}1 & ( q = 0 ) \\ \frac{0.4 - q}{0.4} & ( 0 < q < 0.4 ) \\ 0 & ( 0.4 \leq q \leq 1 )\end{matrix} \\ {μ}_{2} ( q ) = \{ \begin{matrix}0 & ( 0 \leq q < 0.2 ) \\ \frac{q - 0.2}{0.2} & ( 0.2 \leq q < 0.4 ) \\ \frac{0.6 - q}{0.2} & ( 0.4 \leq q < 0.6 ) \\ 0 & ( 0.6 \leq q \leq 1 )\end{matrix} \\ {μ}_{3} ( q ) = \{ \begin{matrix}0 & ( 0 \leq q < 0.4 ) \\ \frac{q - 0.4}{0.2} & ( 0.4 \leq q < 0.6 ) \\ \frac{0.8 - q}{0.2} & ( 0.6 \leq q < 0.8 ) \\ 0 & ( 0.8 \leq q \leq 1 )\end{matrix} \\ {μ}_{4} ( q ) = \{ \begin{matrix}0 & ( 0 \leq q < 0.6 ) \\ \frac{q - 0.6}{0.2} & ( 0.6 \leq q < 0.8 ) \\ \frac{1 - q}{0.2} & ( 0.8 \leq q < 1 ) \\ 0 & ( q = 1 )\end{matrix} \\ {μ}_{5} ( q ) = \{ \begin{matrix}0 & ( 0 \leq q < 0.6 ) \\ \frac{q - 0.6}{0.4} & ( 0.6 \leq q < 1 ) \\ 1 & ( q = 1 )\end{matrix}$$
step 32: selecting a maximum score value of the respective severity grades to substitute into the health status grade membership distribution function, so that the health status membership vectors under single-factor parameter abnormality severity influence may be obtained, which are respectively v_{A2}, v_{B2}, v_{C2}, v_{D2}, v_{E2}.

5. The method for evaluating the health status of a petrochemical atmospheric oil storage tank using data from multiple sources according to claim 4, wherein, the step 4 is further specifically as follows:
respectively performing grey correlation of the health status membership vectors v_{Al}, v_{B1}, v_{C1}, v_{D1}, v_{El} of the respective parameters under dynamic monitoring parameter abnormality probability influence and the health status membership vectors v_{A2}, v_{B2}, v_{C2}, v_{D2}, V_{E2} of the respective parameters under parameter abnormality severity influence with a jth health status grade vector ν₀ⱼ;
where, j is a health status grade, divided into healthy, good, attentive, worse and ill, which is recorded as 1, . . . , 5; that is, ν₀ⱼ is represented as: ν₀₁=(1,0,0,0,0), ν₀₂=(0,1,0,0,0), ν₀₃=(0,0,1,0,0), ν₀₄=(0,0,0,1,0), ν₀₅=(0,0,0,0,1);
according to a formula:
$${ξ}_{kij} ( m ) = \frac{{min}_{i} {min}_{m} \vert {v}_{0 j} ( m ) - {v}_{ki} ( m ) \vert + 0.5 {max}_{i} {max}_{m} \vert {v}_{0 j} ( m ) - {v}_{ki} ( m ) \vert}{\vert {v}_{0 j} ( m ) - {v}_{ki} ( m ) \vert + 0.5 {max}_{i} {max}_{m} \vert {v}_{0 j} ( m ) - {v}_{ki} ( m ) \vert}$$
where m is 1, . . . , 5;
k is parameters A, B, C, D, E;
factor i is 1, 2;
j is 1, . . . , 5;
$${min}_{i} {min}_{m} \vert {v}_{0 j} ( m ) - {v}_{ki} ( m ) \vert$$
is a secondary minimum difference
$${max}_{i} {max}_{m} \vert {v}_{0 j} ( m ) - {v}_{ki} ( m ) \vert$$
is a secondary maximum difference, |ν₀ⱼ(m)−νₖᵢ(m)I is an absolute difference;
finding ξₖᵢⱼ(m) reusing the formula
$${r}_{kij} = \frac{1}{5} {\sum }_{m = 1}^{5} {ξ}_{kij ( m )}$$
Where m is 1, . . . , 5;
k is parameters A, B, C, D, E;
factor i is 1, 2;
j is 1, . . . , 5;
finding rₖᵢⱼ,
reusing the formula
$${r}_{ki}^{′} = \frac{1}{5} {\sum }_{j = 1}^{5} {r}_{kij}$$
calculating to obtain r′ₖᵢ,
calculating to obtain weight vectors Rₖ=(r′ₖ₁, r′ₖ₂), that is: R_{A}=(r′_{A1}, r′_{A2}), R_{B}(r′_{B1}, r′_{B2}), R_{C}(r′_{C1}, r′_{C2}), R_{D}(r′_{D1}, r′_{D2}), R_{E}(r′_{E1}, r′_{E2}),
respectively composing matrices V_{A}, V_{B}, V_{C}, V_{D} and V_{E}, by v_{A1} and v_{A2}, v_{B1} and v_{B2}, v_{C1} and v_{C2}, v_{D1} and v_{D2}, v_{E1} and v_{E2},
$${V}_{A} = ( \begin{matrix}{V}_{A 1} \\ {V}_{A 2}\end{matrix} ) , {V}_{B} = ( \begin{matrix}{V}_{B 1} \\ {V}_{B 2}\end{matrix} ) , {V}_{C} = ( \begin{matrix}{V}_{C 1} \\ {V}_{C 2}\end{matrix} ) , {V}_{D} = ( \begin{matrix}{V}_{D 1} \\ {V}_{D 2}\end{matrix} ) , {V}_{E} = ( \begin{matrix}{V}_{E 1} \\ {V}_{E 2}\end{matrix} ) ,$$
and substituting
Hₖ=Rₖ Vₖ
where, k is parameters A, B, C, D, E;
so that the health status membership vectors of the five parameters A, B, C, D, E of the oil storage tank under comprehensive influence of the parameter abnormality occurrence probability and the parameter abnormality severity may be obtained, which are respectively H_{A}, H_{B}, H_{C}, H_{D}, H_{E}.

6. The method for evaluating the health status of a petrochemical atmospheric oil storage tank using data from multiple sources according to claim 5, wherein, the step 5 is further specifically as follows: setting the oil storage tank dynamic monitoring parameter health status grades under comprehensive influence of the dynamic monitoring parameter abnormality probability and the dynamic monitoring parameter abnormality severity as: healthy, good, attentive, worse and ill; and then obtaining the oil storage tank dynamic monitoring parameter health status grades corresponding to the five parameters A, B, C, D, E of the oil storage tank according to the maximum membership principle, through the health status membership vectors H_{A}, H_{B}, H_{C}, H_{D}, H_{E}.

7. The method for evaluating the health status of a petrochemical atmospheric oil storage tank using data from multiple sources according to claim 6, wherein, the step 6 is further specifically as follows: the respective basic parameters of the oil storage tank including: date of application and transformation, mounting quality of coating, insulation and lining, historical inspection and detection data of atmospheric oil storage tank, construction materials and nominal thickness of wall plates and bottom plates of respective layers, sequentially coding the four items of basic data are as U1, U2, U3, U4; according to the respective items of basic data of the oil storage tank, the oil storage tank status set being: U=(U1, U2, U3, U4); according to the oil storage tank dynamic monitoring parameter health status grades: healthy, good, attentive, worse and ill; then setting the oil storage tank health status grades to respectively correspond to: I, II, III, IV, V, then the oil storage tank status evaluation set being G=(I, II, III, IV, V); and determining the weight coefficients of the four items of basic parameters respectively as: weight W₁, weight W₂, weight W₃, weight W₄, according to the oil storage tank status set and status evaluation set.

8. The method for evaluating the health status of a petrochemical atmospheric oil storage tank using data from multiple sources according to claim 7, wherein, the step 7 is further specifically as follows: calculating the degradation degree according to actual service time of the oil storage tank, according to the basic parameter U1 date of application and transformation; that is, a degradation degree calculation formula being:
Iᵢ=(t/T)^{k}
where: i=1, t is the service time of the oil storage tank; T is average failure life of the oil storage tank; k is a failure index, and k is taken as 1 or 2;
with respect to U2 mounting quality of coating, insulation and lining, U3 historical inspection and detection data of atmospheric oil storage tank, U4 construction materials and nominal thickness of wall plates and bottom plates of respective layers, these basic parameters firstly going through a degradation estimation formula:
lᵢ=(X·P₁+Y·P₂+Z·P₃)/(P+P₂+P₃),i=2,3,4
where: X, Y, Z are coefficients whose values are between 0 and 1, 0 represents healthy, 1 represents completely degraded; P₁, P₂, P₃ are respectively weights of designers, quality inspectors and experts in the industry;
finding a solution, and then calculating in combination with the average failure life of the oil storage tank, by using the formula:
$$\begin{matrix}{l}_{i} = {( \frac{t}{( 1 - {l}_{i}^{′} ) T} )}^{k} & i = 2 , 3 , 4\end{matrix} ;$$
where: t is the service time of the oil storage tank; T is the average failure life of the oil storage tank; k is the failure index, and k is taken as 1 or 2;
calculating the degradation degrees of the basic parameters U2, U3, U4.

9. The method for evaluating the health status of a petrochemical atmospheric oil storage tank using data from multiple sources according to claim 8, wherein, the step 8 is further specifically as follows:
deriving membership of health status grades according to the degradation degrees of the respective basic parameters, by using a ridge distribution membership function:
$${r}_{I} ( {l}_{i} ) = \{ \begin{matrix}1 & ( {l}_{i} = 0 ) \\ 0.5 - 0.5 sin [ π ( {l}_{i} - 0.1 ) / 0.2 ] & ( 0 < {l}_{i} \leq 0.2 ) \\ 0 & ( {l}_{i} > 0.2 )\end{matrix} \\ {r}_{II} ( {l}_{i} ) = \{ \begin{matrix}0 & ( {l}_{i} = 0 ) \\ 0.5 + 0.5 sin [ π ( {l}_{i} - 0.1 ) / 0.2 ] & ( 0 < {l}_{i} \leq 0.2 ) \\ 0.5 - 0.5 sin [ π ( {l}_{i} - 0.35 ) / 0.3 ] & ( 0.2 < {l}_{i} \leq 0.5 ) \\ 0 & ( {l}_{i} > 0.5 )\end{matrix} \\ {r}_{III} ( {l}_{i} ) = \{ \begin{matrix}0 & ( {l}_{i} \leq 0.2 ) \\ 0.5 + 0.5 sin [ π ( {l}_{i} - 0.35 ) / 0.3 ] & ( 0.2 < {l}_{i} \leq 0.5 ) \\ 0.5 - 0.5 sin [ π ( {l}_{i} - 0.65 ) / 0.3 ] & ( 0.5 < {l}_{i} \leq 0.8 ) \\ 0 & ( {l}_{i} > 0.8 )\end{matrix} \\ {r}_{IV} ( {l}_{i} ) = \{ \begin{matrix}0 & ( {l}_{i} \leq 0.5 ) \\ 0.5 + 0.5 sin [ π ( {l}_{i} - 0.65 ) / 0.3 ] & ( 0.5 < {l}_{i} \leq 0.8 ) \\ 0.5 - 0.5 sin [ π ( {l}_{i} - 0.9 ) / 0.2 ] & ( 0.8 < {l}_{i} < 1 ) \\ 0 & ( {l}_{i} \geq 1 )\end{matrix} \\ {r}_{V} ( {l}_{i} ) = \{ \begin{matrix}0 & ( {l}_{i} \leq 0.8 ) \\ 0.5 + 0.5 sin [ π ( {l}_{i} - 0.9 ) / 0.2 ] & ( 0.8 < {l}_{i} < 1 ) \\ 1 & ( {l}_{i} \geq 1 )\end{matrix}$$
so that a fuzzy evaluation matrix with the degradation degree as evaluation criteria may be obtained as follows:
$${R}_{i} = ( \begin{matrix}{r}_{I} ( {l}_{i} ) , & {r}_{II} ( {l}_{i} ) , & {r}_{III} ( {l}_{i} ) , & {r}_{IV} ( {l}_{i} ) , & {r}_{V} ( {l}_{i} )\end{matrix} ) \\ R = ( \begin{matrix}{r}_{I} ( {l}_{1} ) , & {r}_{II} ( {l}_{1} ) , & {r}_{III} ( {l}_{1} ) , & {r}_{IV} ( {l}_{1} ) , & {r}_{V} ( {l}_{1} ) \\ {r}_{I} ( {l}_{2} ) , & {r}_{II} ( {l}_{2} ) , & {r}_{III} ( {l}_{2} ) , & {r}_{IV} ( {l}_{2} ) , & {r}_{V} ( {l}_{2} ) \\ {r}_{I} ( {l}_{3} ) , & {r}_{II} ( {l}_{3} ) , & {r}_{III} ( {l}_{3} ) , & {r}_{IV} ( {l}_{3} ) , & {r}_{V} ( {l}_{3} ) \\ {r}_{I} ( {l}_{4} ) , & {r}_{II} ( {l}_{4} ) , & {r}_{III} ( {l}_{4} ) , & {r}_{IV} ( {l}_{4} ) , & {r}_{V} ( {l}_{4} )\end{matrix} )$$
then the fuzzy comprehensive evaluation of the oil storage tank basic parameters being:
E=W·R
where, W is the weight coefficients of the four items of basic parameters W=(W₁, W₂, W₃, W₄).

10. The method for evaluating the health status of a petrochemical atmospheric oil storage tank using data from multiple sources according to claim 9, wherein, the step 9 is further specifically as follows: obtaining values of healthy, good, attentive, worse and ill which the oil storage tank belongs to from the fuzzy comprehensive evaluation results; and then judging which state among healthy, good, attentive, worse and ill the oil storage tank basic parameters belong to according to the maximum membership principle.
